(19) United States
(12) Patent Application Publication
(10) Pub. No.: US 2010/0052448 A1
(43) Pub. Date: Mar. 4, 2010

(54) DYNAMOELECTRIC MACHINE ELECTRICAL SYSTEM AND METHOD

(75) Inventor: THOMAS A. MERRILL, NOBLESVILLE, IN (US)

Correspondence Address: CANTOR COLBURN, LLP, 20 Church Street, 22nd Floor, Hartford, CT, 06103, US

(73) Assignee: REMY TECHNOLOGIES, L.L.C., PENDLETON, IN (US)

(21) Appl. No.: 12/203,229

(22) Filed: Sep. 3, 2008

(51) Int. Cl. H02K 5/00; H02K 11/00

(52) U.S. Cl. 310/91; 310/71

(57) ABSTRACT

Disclosed herein is a vehicle dynamoelectric machine electrical system. The system includes, a housing having a boss, and at least one electrically insulative member in operable communication with the boss and capable of electrically isolating the housing from a bracket configured to mount the housing.

### BACKGROUND OF THE INVENTION

The increasing power density of vehicle dynamoelectric machines has resulted in some dynamoelectric machines using housings of the machine as heat sinks for electrical components and circuits. Designers typically connect the negative of a circuit to the housing and the housing is electrically connected to the vehicle ground through mounting to a bracket. This system often works fine; however, in some applications disruptive electromagnetic interference (EMI) can emanate from the vehicle ground due to this grounding methodology. Systems and methods to reduce or minimize the EMI would be well received in the industry.

### BRIEF DESCRIPTION OF THE INVENTION

Disclosed herein is a vehicle dynamoelectric machine electrical system. The system includes, a housing having a boss, and at least one electrically insulative member in operable communication with the boss and capable of electrically isolating the housing from a bracket configured to mount the housing.

Further disclosed herein is a method of controlling electrical transients in a vehicle electrical system. The method includes, electrically connecting a negative portion of a circuit of a dynamoelectric machine to a housing, and electrically insolating the housing from a bracket securing the dynamoelectric machine to a vehicle.

### BRIEF DESCRIPTION OF THE DRAWINGS

The following descriptions should not be considered limiting in any way. With reference to the accompanying drawings, like elements are numbered alike:

FIG. 1 depicts a perspective view of a dynamoelectric machine having a grounding system disclosed herein with a cover of the dynamoelectric machine removed; and

FIG. 2 depicts a cross sectional view through a dynamoelectric machine mounting bolt.

### DETAILED DESCRIPTION OF THE INVENTION

A detailed description of one or more embodiments of the disclosed apparatus and method are presented herein by way of exemplification and not limitation with reference to the Figures.

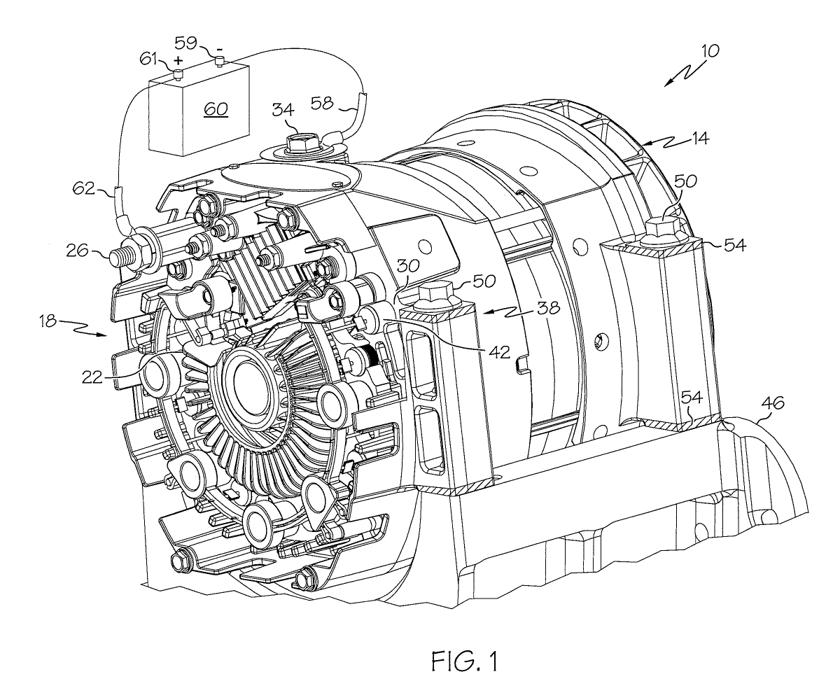

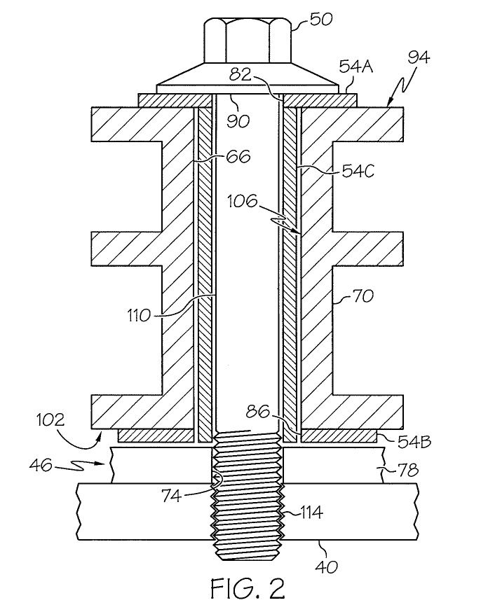

Referring to FIG. 1, an embodiment of the vehicle dynamoelectric machine grounding system 10 disclosed herein is illustrated. The system 10, among other things, includes a dynamoelectric machine 14, shown here as an alternator, a circuit 18 having a positive portion 22 electrically connected to a positive (B+) terminal 26 and a negative portion 30 electrically connected to a negative (B−) terminal 34 and electrically connected to a housing 38. The negative portion 30 and B− terminal 34 are electrically connected to the housing 38 by a plurality of negative diodes 42 that are press fitted into and electrically connected to the housing 38 directly, or a separate member that is electrically connected to the housing 38. This press fit between the diodes 42 and the housing 38 allow heat generated in the diode 42 to efficiently pass into the housing 38 thereby using the housing 38 as a heat sink. A bracket 46 and one or more of bolt(s) 50 structurally mounts the housing 38 to an engine block 40. Electrically nonconductive insulators 54 electrically insulate the housing 38 from the bolt(s) 50 and the bracket 46 as will be described in detail with reference to FIG. 2 below. As such, the housing 38 is electrically insolated from the bracket 46 and engine block 40, unlike grounding systems that are typical in automotive and heavy-duty vehicle applications. A cable 58 connected to the B− terminal 34 is connected directly to a negative terminal 59 of a battery 60. Similarly, a cable 62, connected to the B+ terminal 26, is directly connected to a positive terminal 61 of the battery 60.

The high capacitance of the battery 60 allows large amounts of current to flow to and from the battery 60 with little resistance. By connecting the negative portion 30 of the circuit 18, shown herein as a regulator, directly to the battery 60 through the cable 58, and not via engine parts and components of a vehicle frame (not shown), EMI is much easier to control. This is due to the control over mechanical parameters, such as, size, shape and routing and electrical parameters, such as, resistance, inductance and capacitance, for example, available with the cable 58 that is not available with a ground that runs through multiple paths of multiple vehicle components.

Referring to FIG. 2, the alternator 14, in this embodiment, is structurally mounted to the bracket 46 by the one or more bolt(s) 50, with two bolts 50 being shown and two bolts 50 being hidden from view (in FIG. 2) on a backside of the alternator 14. Each of the bolts 50 passes through a hole 66 in a boss 70 protruding from the housing 38 and a hole 74 in a flange 78 of the bracket 46. Additionally, each bolt 50 passes through nonconductive insulators 54 that electrically insulate the bolt 50 and bracket 46 from the housing 38. The insulators 54 consist of three portions, a first insulating portion 54A, a second insulating portion 54B and a third insulating portion 54C. The portions 54A and 54B are flat with holes 82 and 86 therethrough respectively, through which the bolt 50 passes. The first insulating portion 54A electrically insulates a first surface 94 of the boss 70 from a head 90 of the bolt 50. Similarly, the second insulating portion 54B electrically insulates a second surface 102 of the boss 70 from the flange 78. The third, cylindrically shaped, insulating portion 54C electrically insulates an inner surface 106 of the boss 70 from a shaft 110 of the bolt 50. The bolt 50 is threadably engaged with threaded hole 114 in the engine block 40 to axially compress the first insulating portion 54A, the boss 70, the second insulating portion 54B and the flange 78 between the engine block 40 and the head 90. Alternately the bolt 50 can be threaded into a threaded hole in the bracket directly. It should be noted that the three insulating portions 54A, 54B, 54C, although disclosed in this embodiment as being three separate parts, may be combined as two parts or even as a single part depending upon specifics of a particular application and methods of assembly employed. The portions 54A, 54B and 54C may be fabricated of any suitably durable insulating material, such as, ceramic, polymeric, elastomeric or paper, for example.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A vehicle dynamoelectric machine electrical system, comprising:
a housing having a boss; and
at least one electrically insulative member in operable communication with the boss and capable of electrically isolating the housing from a bracket configured to mount the housing.

2. The vehicle dynamoelectric machine electrical system of claim 1, wherein a dynamoelectric machine of the vehicle dynamoelectric machine electrical system is an alternator.

3. The vehicle dynamoelectric machine electrical system of claim 1, further comprising a circuit in electrical communication with the housing.

4. The vehicle dynamoelectric machine electrical system of claim 3, wherein the circuit includes a regulator.

5. The vehicle dynamoelectric machine electrical system of claim 3, wherein the circuit has a positive portion electrically connected to a battery.

6. The vehicle dynamoelectric machine electrical system of claim 3, wherein the circuit has a negative portion electrically connected to the housing.

7. The vehicle dynamoelectric machine electrical system of claim 6, wherein the circuit includes at least one diode electrically connected to the negative portion.

8. The vehicle dynamoelectric machine electrical system of claim 7, wherein the at least one diode is press fit into the housing.

9. The vehicle dynamoelectric machine electrical system of claim 6, wherein the negative portion is electrically connected to a battery.

10. The vehicle dynamoelectric machine electrical system of claim 1, wherein at least one of the at least one electrically insulative member is made from at least one of a ceramic, polymeric, elastomeric and paper material.

11. A method of controlling electrical transients in a vehicle electrical system, comprising:
electrically connecting a negative portion of a circuit of a dynamoelectric machine to a housing; and
electrically insolating the housing from a bracket securing the dynamoelectric machine to a vehicle.

12. The method of controlling electrical transients in a vehicle electrical system of claim 11, further comprising electrically connecting the housing to a battery.

13. The method of controlling electrical transients in a vehicle electrical system of claim 12, wherein the electrically connecting the housing to the battery includes running a cable directly from the housing to the battery.
